(19) United States
(12) Patent Application Publication
(10) Pub. No.: US 2010/0018309 A1
(43) Pub. Date: Jan. 28, 2010

(54) FLUID LEVEL MEASURING METHOD AND SYSTEM THEREFOR

(76) Inventors: Pino Marcovecchio, Montreal (CA); Elad Wallach, Lachine (CA); Uri Agam, Montreal (CA)

Correspondence Address: HARRINGTON & SMITH, PC, 4 RESEARCH DRIVE, Suite 202, SHELTON, CT, 06484-6212, US

(21) Appl. No.: 12/449,125

(22) PCT Filed: Feb. 20, 2008
(86) PCT No.: PCT/CA2008/000330

§ 371 Date: Sep. 18, 2009

Related U.S. Application Data
(60) Provisional application No. 60/890,939, filed on Feb. 21, 2007.

(51) Int. Cl. G01F 23/296

(52) U.S. Cl. 73/290 V

(57) ABSTRACT

An ultrasound system for measuring the fluid level in a tank includes means for emitting an ultrasound detecting beam towards a surface of the fluid in the tank from a first position relative to the tank, yielding at least a portion of a path of the ultrasound detecting beam being generally perpendicular to the bottom of the tank and defining an axis intersecting the bottom of the tank, the first position being adjacent the bottom of the tank; means for receiving echoes from the ultrasound detecting beam reflected from the surface of the fluid in the tank at a second position biased from the first position; and means for determining the fluid level using the echoes received from the ultrasound detecting beam and a distance between the first and second positions. Such a system allows eliminating the limitation caused by the transducers' dead zone without requiring the use of a waveguide. A reference target can be used to calibrate the system for the speed of sound of the fluid mixture in the tank and for measuring the fluid mixture density.

### FIELD

The present invention concerns fluid level measuring. More specifically, the present invention concerns a method and system for measuring the level of fluid, such as liquids and gas, in a tank using ultrasound.

### BACKGROUND

Many methods and systems are known to measure the fluid level in a container including those using ultrasounds.

Some of these last techniques are based on ultrasound travelling along a waveguide including discontinuities, where variations in the waveforms along the waveguide are indicative of the liquid level.

According to other techniques, the ultrasound beam is emitted within a conduit towards the surface of the liquid and the delay to receive the echo is indicative of the distance from the source and therefore of the liquid level.

Other method and system include a single transducer mounted to the bottom of the tank so that its ultrasound beam is aimed upwardly towards the surface of the fluid.

A drawback of all known ultrasound techniques from the prior art, involving or not the use of a waveguide or conduit, is that they do not allow eliminating the limitation caused by the transducer's dead zone.

Indeed, it has been found in known techniques that a minimal distance from the bottom of the tank, which corresponds to this transducer's dead zone, cannot be measured. As it is commonly known in the art, the dead zone of an ultrasound transducer equates to the distance from the surface of the transducer to the nearest object that may be imaged. It corresponds to the ring down time of the transducer equated to distance.

### BRIEF DESCRIPTION OF THE DRAWINGS

In the appended drawings:

FIG. 1 is schematic view of a fluid level measuring system according to a first illustrative embodiment of the present invention, the system being illustrated mounted to a tank for measuring the level of liquid therein; the tank being shown in cross-section;

FIGS. 2 and 2a are schematic views illustrating ultrasound sensor assemblies for measuring the fluid level in a tank according to second and third illustrative embodiments of the present invention; further illustrating the use of a reference target, the assembly of FIG. 2a being mounted inside the tank;

FIG. 3 is a schematic view of a fluid level measuring system according to a fourth illustrative embodiment of the present invention, the system being illustrated mounted to a tank for measuring the level of liquid therein; the tank being shown in cross-section;

FIG. 4 is a schematic view of the system from FIG. 3, FIGS. 3 and 4 illustrating the use of a beam expander to accommodate for the tilt of the tank; the tank being illustrated tilted in FIG. 4;

FIGS. 5, 6, 7 and 8 are schematic views of ultrasound sensor assemblies for measuring the fluid level in a tank using beam expenders, reflectors and/or reference targets, according to respectively fifth, sixth, seventh and eight illustrative embodiments of the present invention;

FIG. 9 is as schematic cross section of a fuel pipe, incorporating a density meter for measuring the amount of ethanol in a gasoline mixture, according to a ninth illustrative embodiment of the present invention; and

FIGS. 10, 11 and 12 are schematic views of fluid level measuring systems according to tenth, eleventh and twelfth illustrative embodiments of the present invention, the systems being illustrated mounted to a tank for detecting when the level of liquid reaches respectively one or a plurality of predetermined level in the tank; the tank being shown in cross-section.

### DETAILED DESCRIPTION

More specifically, in accordance with a first aspect of the present invention, there is provided a method for measuring at least one fluid level in a tank including at least one fluid comprising:

emitting an ultrasound detecting beam towards a surface of the at least one fluid in the tank from a first position relative to the tank, yielding at least a portion of a path of the ultrasound detecting beam being generally perpendicular to the bottom of the tank and defining an axis intersecting the bottom of the tank; the first position being adjacent the bottom of the tank;

receiving echoes from the ultrasound detecting beam reflected from the surface of the at least one fluid in the tank at a second position biased from the first position; and

determining the at least one fluid level using the echoes received from the ultrasound detecting beam and a distance between the first and second positions.

According to a second aspect of the present invention, there is provided a sensor assembly for measuring at least one fluid level in a tank comprising:

an ultrasonic transducer assembly mounted to the tank so as to emit an ultrasound detecting beam along a path generally parallel to the bottom of the tank and for receiving ultrasound echoes incoming along the path; the ultrasonic transducer assembly being characterized by a dead zone; and

a primary reflector mounted to the tank along the path of the ultrasound beam for reflecting the ultrasound detecting beam towards a surface of the at least one fluid in the tank and for reflecting back the ultrasound echoes received therefrom; the primary reflector being distanced from the ultrasonic transducer assembly from at least the length of the dead zone of the ultrasonic transducer.

According to a third aspect of the present invention, there is provided a sensor assembly for measuring fluid level in a tank comprising:

a first ultrasound transducer mounted to the tank for emitting an ultrasound detecting beam towards a surface of at least one fluid in the tank; and

a second ultrasound transducer mounted to the tank adjacent the first ultrasound transducer for receiving ultrasound echoes from the first detecting beam reflected from the surface of the at least one fluid in the tank.

According to a fourth aspect of the present invention, there is provided a sensor assembly for measuring at least one fluid level in a tank comprising:

ultrasound emitting means for emitting an ultrasound detecting beam towards a surface of at least one fluid in the tank from a first position relative to the tank yielding at least a portion of a path of the ultrasound detecting beam being generally perpendicular to the bottom of the tank and which defines an axis intersecting the bottom of the tank; the first position being adjacent the bottom of the tank;

ultrasound receiving means for receiving echoes from the ultrasound detecting beam reflected from the surface of the at least one fluid in the tank at a second position biased from the first position; and

means for determining the at least one fluid level using the echoes received from the ultrasound detecting beam and a distance between the first and second positions.

According to a fifth aspect of the present invention, there is provided an integrated method for measuring a fluid mixture level and density in a tank including a fluid mixture comprising:

emitting an ultrasound detecting beam i) towards a surface of the fluid mixture in the tank and ii) towards a reference target in the tank from a first position relative to the tank, yielding at least a portion of a path of the ultrasound detecting beam being generally perpendicular to the bottom of the tank and which defines an axis intersecting the bottom of the tank; the first position being adjacent the bottom of the tank;

receiving echoes from the ultrasound detecting beam reflected from a) the surface of the fluid in the tank and from b) the reference target at a second position biased from the first position;

determining the fluid mixture level using the echoes received from the ultrasound detecting beam and a distance between the first and second positions;

measuring a temperature of the fluid mixture in the tank; and

using the echoes from the ultrasound detecting beam reflected from the reference target and the temperature of the fluid mixture in the tank to determine the density of the fluid mixture.

According to a sixth aspect of the present invention, there is provided a method for measuring the density of a fluid mixture comprising:

providing an identity of the fluid mixture;

measuring a temperature of the fluid mixture;

emitting an ultrasound detecting beam towards a reference target in the fluid mixture; the reference target being positioned at a predetermined distance from a transducer emitting the ultrasound detecting beam;

receiving echoes from the ultrasound detecting beam reflected from the reference target after a measured time delay after the emitting an ultrasound detecting beam towards a reference target;

using the measured time delay, the temperature of the fluid mixture and the identity of the fluid mixture, determining the ratio of at least one fluid in the fluid mixture.

The expression tank should be construed herein as including any container or recipient closed or opened for example at its top, for including fluids such as gas or liquid or a mixture thereof.

Compared with conventional ultrasound level measuring methods and systems for tank, the present method and system allow mounting the transducer inside or on the side of the tank which allows protecting the assembly from accidental contact with the road following bumps.

The device can measure multiple liquid levels of fluids such as water and fuel.

A sensor assembly for measuring the fluid level in a tank according to the present invention presents the following advantages compared with most ultrasound-based level measuring systems from the prior art using acoustic guides:
elimination of the dead zone;
allows accommodating for tank tilt;
includes less parts in the system;
does not require pressure release opening and may operate inside the tank as submarine for ease of installation;
no overshoot or undershoot of the liquid in the waveguide; and
does not require addressing internal reflection and air/gas bubbles in the waveguide; and
no limitation to the sensor assembly to include a waveguide having a configuration that has to remain constant throughout the life of the product.

Other objects, advantages and features of the present invention will become more apparent upon reading the following non restrictive description of illustrated embodiments thereof, given by way of example only with reference to the accompanying drawings.

In the following description, similar features in the drawings have been given similar reference numerals, and in order not to weigh down the figures, some elements are not referred to in some figures if they were already identified in a precedent figure.

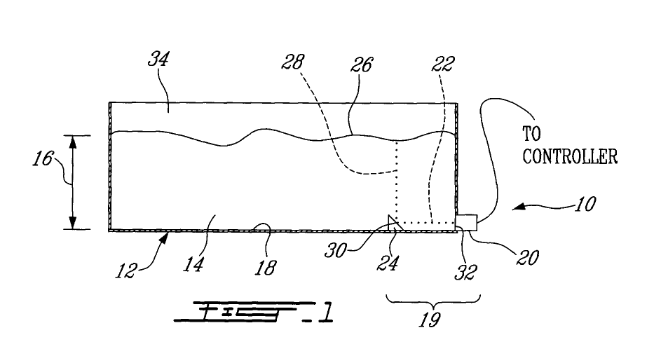

A level measuring system 10 according to a first illustrative embodiment of the present invention will now be described with reference to FIG. 1.

The system 10 is illustrated mounted to a tank 12, which is filled with a fluid in the form of a liquid 14. As will be described furtherin, a level measuring system according to the present invention can measure a plurality of levels resulting from the presence of a plurality of fluids in the tank, which can be in the form of separated gases or liquids or a combination thereof which are superimposed in the tank 12.

As will now be described, the system 10 allows measuring the level 16 of liquid 14 in the tank 12 from the bottom 18. As will become more apparent upon reading the following description, other relative height of fluid than the level 16 relative to the bottom of the tank 12 can be measured in the tank 12 by appropriately positioning the measuring system 10 in the tank 12.

The system 10 comprises a sensor assembly 19 coupled to a controller (not shown) that receives and interprets the detected signals using algorithms so as to determine the liquid level 16 in the tank 12. The controller can take many forms, from a vehicle's onboard controllers, when the tank 12 is a vehicle's gas tank, to electronic circuitry configured for that particular purpose and to which the sensor assembly 19 is connected using wires. The sensor assembly 19 can alternatively or further be coupled to the controller wirelessly. The controller can also be integral to the sensor assembly 19.

The sensor assembly 19 comprises an ultrasonic transducer 20 mounted to a side wall of the tank 12 outside thereof for emitting an ultrasound detecting beam (not shown) along a first horizontal path 22 generally parallel to the bottom 18 of the tank 12 and for receiving ultrasound echoes incoming along the path 22.

The transducer 20 is interfaced to the tank's external frame and is configured and calibrated before operation to detect through the liquid tank 12 and also to translate height into volume. Since it is believed to be within the reach of a person skilled in the art to conceive or select such a transducer, it will not be described furtherin in more detail.

The assembly 19 further comprises a reflector 24 mounted to the tank 12 along the path 22 of the ultrasound beam for reflecting the ultrasound detecting beam towards the surface 26 of the liquid 14 and for reflecting back to the transducer 20 along the path 22 the ultrasound echoes received from the surface 26 and indicative therefrom.

The expression “path” should be construed herein as including the field of view of the transducer 20 as allowed by the assembly 19. It should not be construed as meaning that the ultrasound detecting beam and the returning ultrasound echoes necessarily follow a same course in opposite direction for example.

The reflector 24 is sufficiently distanced from the ultrasonic transducer 20 to compensate for the dead zone which characterizes the ultrasonic transducer 20. The distance between the reflector 24 to the transducer 20 allows sufficient time for the transducer 20 to become sensitive after the emission of the burst of signals.

It is to be noted that, for illustrative purposes, the dimensions of the transducer 20 and reflector 24 have been exaggerated in FIG. 1 relatively to those of the tank 12. The transducer 20 and reflector 24 are mounted to the tank 12 so that the portion of the detecting beam which issues from the reflector 24 in direction of the surface of the liquid 26 issues therefrom from a position as close as possible to the bottom 18 of the tank 12. In some application however, such a precision in the liquid level measurement is not required.

The reflector 24 can take any form including a portion of a body having a 45 degrees angle made of a material that reflects ultrasounds in the fluid. The reflector 24 can be mounted to the tank 12 independently of the transducer 20 or can be assembled to the transducer 20 to form a single device that is secured to the tank 12.

The reflector 24 acts as a folding element for the ultrasound beam and for the echoes reflected from the fluid interface 26. The use of the reflector 24 allows detecting minimal levels which can be very low relatively to the bottom 18 of the tank 12, by allowing the ultrasound beam to extend parallel to the bottom 18 of the tank 12. According to the sensor assembly configuration shown in FIG. 1, a single transducer 20 can be used, and the approach ring of the transducer 20 has no effect on the minimal level that can be detected as long as the distance between the reflector 24 and the transducer 20 is greater than the dead zone.

Even though the system 10 includes a reflector 24 provided with a 45-degrees angle that causes the beam to be reflected at 90 degrees from its initial path 22, a system for measuring fluid level in a tank according to the present invention is not limited to such a reflector. According to a further illustrative embodiment (not shown), a reflector configured to reflect the ultrasound beam at another angle is provided. Generally stated, the sensor assembly can be provided with one or more reflector that yields an acoustic beam path adapted for the container and fluid therein. For example, the system can be configured to yield a beam path which includes a plurality of direction changes, which can be advantageous where the tank shape is irregular such as in modern fuel tanks. The first reflector can be seen as a primary reflector and any further reflector can be seen as secondary reflectors.

The reflector 24 can further act in some application as an element to shape the beam angle. It can also be used as a collector for the returning beam.

In summary, the following method 200 is implemented in the system 10 to measure the fluid level 16 in the tank 12:

202—an ultrasound detecting beam is emitted towards the surface 26 of the fluid 14 in the tank 12 from a first position 30 relative to the tank 12 so as to yield a portion of a path of the ultrasound detecting beam which is generally perpendicular to the bottom of the tank 12 and which defines an axis intersecting the bottom of the tank 12. The first position 30 is defined by the surface of the reflector 24 where the detecting beam is reflected;

204—receiving echoes from the ultrasound detecting beam reflected from the surface 26 of the fluid 14 in the tank 12 at a second position 32 biased from the first position. The second position 32 is defined by the ultrasound transducer's face; and

206—determining the fluid level using the echoes received from the ultrasound detecting beam and the distance between the first and second positions 30 and 32.

As mentioned hereinabove, the first position 30 is adjacent the bottom of the tank 12.

In step 206, the controller measures the time required for the sound waves to propagate from the transducer 20 to the plane where the liquid interfaces with the gas or with another fluid above it or to the container wall depending on the application, the configuration of the tank 12 and/or the level of fluid 14 therein. In the example illustrated in FIG. 1, this plane is defined by the interface 26 between the liquid 14 and air 34 above it. This plane 26 acts as a partial reflector creating echoes which return to the transducer 20. The controller measures the time of flight of the beam and, based on the known or calculated speed of sound in the fluid 14, it calculates the distance between the transducer 20 and the interface 26.

The fluid level 16 is determined based on the speed of sound in the fluid 14 and the net travel time in the vertical path 28. The horizontal paths 22 are eliminated in the calculations, which are done by the controller.

Even though the transducer 20 is illustrated in FIG. 1 mounted on the side of the tank 12, outside thereof, the transducer 20 can also be in the form of a sealed device immerged in the fluid 14.

The transducer can also be mounted in the tank 12 encapsulated in a sealed housing (not shown). The reflector 30 is of course submerged completely in the tank 12. In some application, a partially submerged reflector 30 can be provided. In the case where the tank 12 does not include a corrosive fluid or wherein the transducer or the housing it is encapsulated in is resistant to the corrosive material, the transducer 20 may be directly submerged in the fluid while the rest of the system remains as described above.

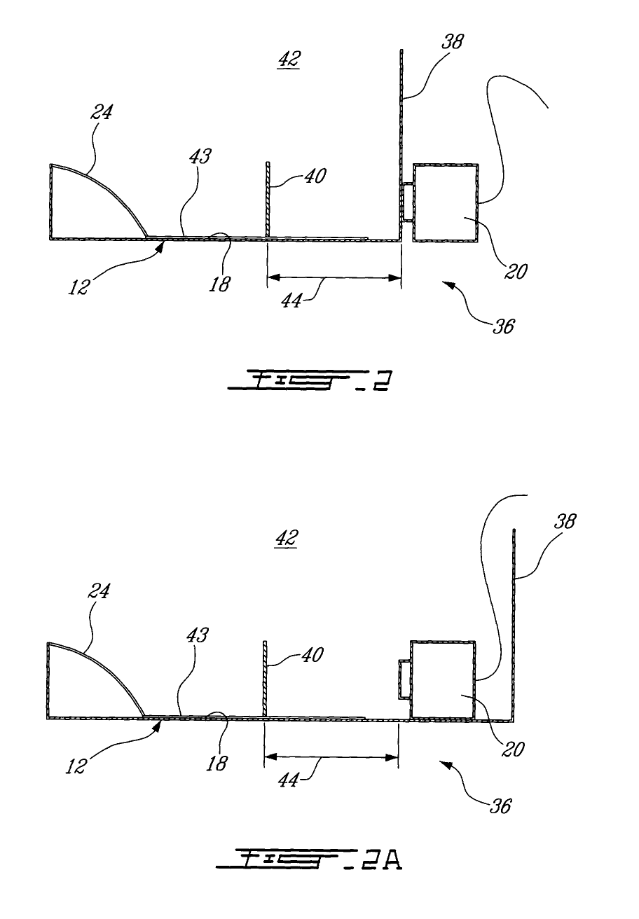

A sensor assembly 36 for measuring the fluid level in a tank according to a second illustrative embodiment of the present invention will now be described with reference to FIG. 2. Since the sensor assembly 36 is similar to the assembly 19, and for concision purpose, only the differences between the two assemblies 19 and 36 will be described herein.

In addition to the ultrasonic transducer 20, which is mounted to the tank side wall 38 outside thereof, and to the reflector 24, operatively mounted as described hereinabove with reference to FIG. 1, the sensor assembly comprises a reference target 40. The sensor assembly 36 is part of a system 42, which further includes a controller (not shown).

The reference target 40 is in the form of a body or object mounted to the floor 18 of the tank 12 and/or to the reflector 24 so as to be positioned along the path 22. The target 40 is sufficiently small so as not to block the ultrasound beam from the transducer 20. It is also located beyond the transducer 20 dead zone.

According to the second illustrative embodiment, the reference target is slidably mounted to the floor 18 of the tank 12 via a rail 43 so that its distance 44 relatively to side wall 38 of the tank 12 and therefore to the transducer 20 can be modified.

The reference target 40 allows calibrating the system 42 for the speed of sound in the fluid or fluid mixture contained in the tank 12. As it is believed to be well known in the art, the speed of sound in the tank may vary with the fluid temperature, the nature of the fluid or mixture or with any other parameters which contribute to the change of speed of sound in the fluid. Since any of these parameters may vary over time, an initial calibration can be executed while doing any fluid level measurements in the tank, using the reference target 40 and then further calibrations can be done at fixed or variable intervals to cope for changes in the shape of the tank 12 for example.

The target 40, the reflector 24 and/or the transducer 20 can be assembled or be part of a single device or body so as to reduce the number of components in the system 42 and also for ease of installation or be mounted independently to the floor of the tank 12 or to a pump installed inside the tank 12. Also, similarly to what has been discussed with reference to the sensor assembly 10, the assembly 36 can be mounted to the tank 12 at another position than to or adjacent the bottom thereof so as to measure the height of fluid relatively to another reference.

The echoes reflected back from the target 40 and the delay between the emission of the ultrasound beam from the transducer 20 and the corresponding returned echoes can be used by the controller to calculate further information when known parameters are fed to the controller.

For example, when a plurality of known fluids is mixed in the tank, the identity of the fluid mixture ratio can be determined providing the following parameters: the speed of sound for different mixture ratios, the distance 44 of the reference target 40 to the transducer 20 and the mixture temperature, which can be determined by adding a thermometer in the tank for example.

For example, to measure the content of Ethanol in the gasoline, the speed of sound in the mixture depends on the percentage of Ethanol in the mixture. It also depends on the mixture temperature. Therefore providing the temperature, the time of flight to the reference target and the distance 44, the speed of sound and the ratio can be calculated by the controller.

Conversely, the temperature of a known fluid or fluid mixture in the tank can be computed by the controller, providing the distance 44 of the reference target 40 to the transducer 20 and knowing the ratio in the mixture.

As a person skilled in the art will now appreciate, providing a reference target 40 between the transducer and the reflector 24 allows the calibration of the ultrasound flight time to the reflecting surface 26 with regards to the nature of the fluid and the average fluid temperature as mentioned hereinabove.

In certain application the reflector 24 can be used as a reference target and so is a tank wall.

A self calibration technique similarly to the one described in U.S. patent application Ser. No. 11/029,415, titled “Method and System for Measuring Fluid Level in a Container”, naming Agam et al. as the inventors and published on Aug. 3, 2006 under No. US-2006-0169055-A1, which is incorporated herewith by reference, can further be implemented in the controller. The use of a ‘wave guide’, which is described in the '415 application is of course not required in a method and system according to the present invention.

According to a further illustrative embodiment (not shown), the transducer 20 can be replaced by a couple of transducers mounted to the tank side by side similarly to the transducer 20. The couple of transducers include an emitter for sending an ultrasound detecting beam towards the target 40 and the reflector 24 and a receiver for collecting echoes reflected therefrom.

According to third illustrative embodiment of an ultrasound sensor assembly from the present invention (see FIG. 2a), the one or two transducers 45 from the assembly 36 is/are mounted to the bottom of the tank inside thereof.

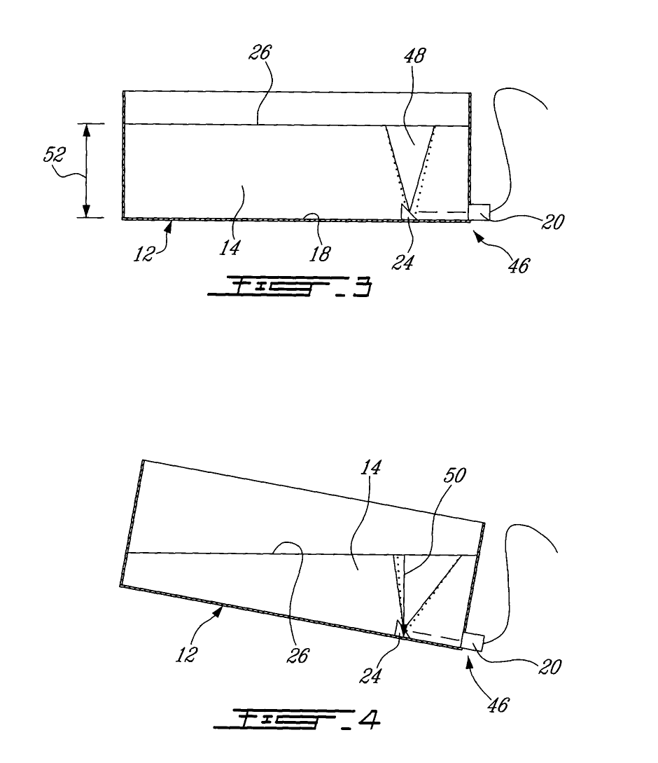

FIGS. 3 and 4 illustrate an ultrasound sensor assembly 46 for measuring the fluid level in a tank 12 according to a fourth illustrative embodiment of the present invention. Since the assembly 46 is similar to the assembly 19, only the differences between these two assemblies will be described furtherin.

In addition to the transducer 20 and reflector 24, the ultrasound sensor assembly 46 further includes a beam shaper and collector such as a beam expander that increases the ultrasound energy collected, yielding a wider beam 48 downstream from the reflector 24.

Increasing the beam size downstream from the reflector 24 causes a plurality of echoes resulting from a single ultrasound detecting beam to reflect from the surface 26 of the fluid 14. As illustrated in FIG. 4, when the tank 12 is tilted, the reflected beam may tilt outside the collection area 24. Widening of the beam increases the probability that at last a portion of the energy is collected, thereby allowing the level measurement to take place. Without the use of such beam expander, statistics may have to be used to compensate for the tilt.

Even though the beam expander is illustrated in FIGS. 3 and 4 as a single element 24, which also acts as the reflector 24, the beam expander and bear collector can be provided as an independent device secured to the reflector 24 or to the tank floor 18 as will be described hereinbelow.

In further illustrative embodiment, the beam shape transformer is in the form of a beam focusing element or device (not shown).

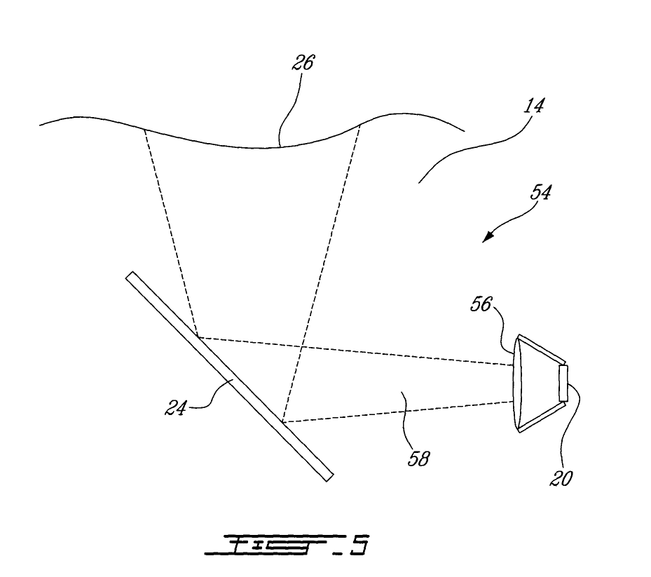

As can be seen in FIG. 5, which illustrates an ultrasound sensor assembly 54 for measuring the fluid level in a tank (not shown) according to a fifth illustrative embodiment of the present invention, a beam expander can further be provided on the transducer 20.

The assembly 54 comprises an ultrasound transducer 20 provided with a collecting aperture 56, which can be in the form for example of an ultrasound horn operatively mounted to the transducer 20 to increase or decrease the width of the ultrasound detecting beam 58 and increase the collecting cross-section of the transducer thereof, 24.

Since ultrasound horns are believed to be well-known in the art, they will not be described furthering in more detail.

Even though a calibration target, such as the target 40 is not illustrated in FIG. 5, such a target can be added to the assembly 54 or 24 to cope for the change in the speed of sound in the fluid 14 as it has been explained hereinabove with reference to FIG. 2.

As will now become apparent with reference to further illustrative embodiments of the present invention, numerous other variations in the ultrasound sensor assembly are possible within the scope of the present invention, allowing for example to minimize the detection limitation inherent to the dead zone.

In FIG. 6 a sensor assembly 60 for measuring the level of fluid in a tank (not shown) according to a sixth illustrative embodiment of the present invention is shown.

The assembly 60 comprises two side by side transducers 66-68 and a combined reflector/target assembly 70. The two transducers 66-68 are mounted to the side of the tank (not shown) outside thereof. A first one of the two transducers 66-68 acts as an ultrasound emitter 66 that emits an ultrasound detecting beam 72 along a first horizontal path 74. The second transducer is an ultrasound receiver 68 for receiving ultrasound echoes reflected from the fluid only along a second path 76 parallel to the first path 74. This approach also allows elimination of the dead zone while allowing the calibration to take place.

The combined reflector/target assembly 70 is mounted to the tank along the paths 74-76 for reflecting the ultrasound detecting beam towards the surface 26 of the fluid 14 and for reflecting back to the transducer 68 the ultrasound echoes received from the surface 26 and indicative therefrom along the path 76. The assembly 70 includes a target portion 78 and a reflector portion 79. The target portion 78 is in the line of sight of the emitter 66.

In operation of the assembly 60, the ultrasound emitter 66 emits an ultrasound beam towards the reflector assembly 70 which reflects the beam towards the fluid surface or interface 26. The echoes reflected from the interface 26 are reflected back to the receiver 68, which is positioned adjacent the emitter 66.

The echoes indicative of the target portion 78 received by the transducer 66 can be used to calibrate the system for the difference in the speed of sound, due for example to a change in the fluid mixture as explained hereinabove. In addition to the assembly 60, the system includes a controller as described hereinabove.

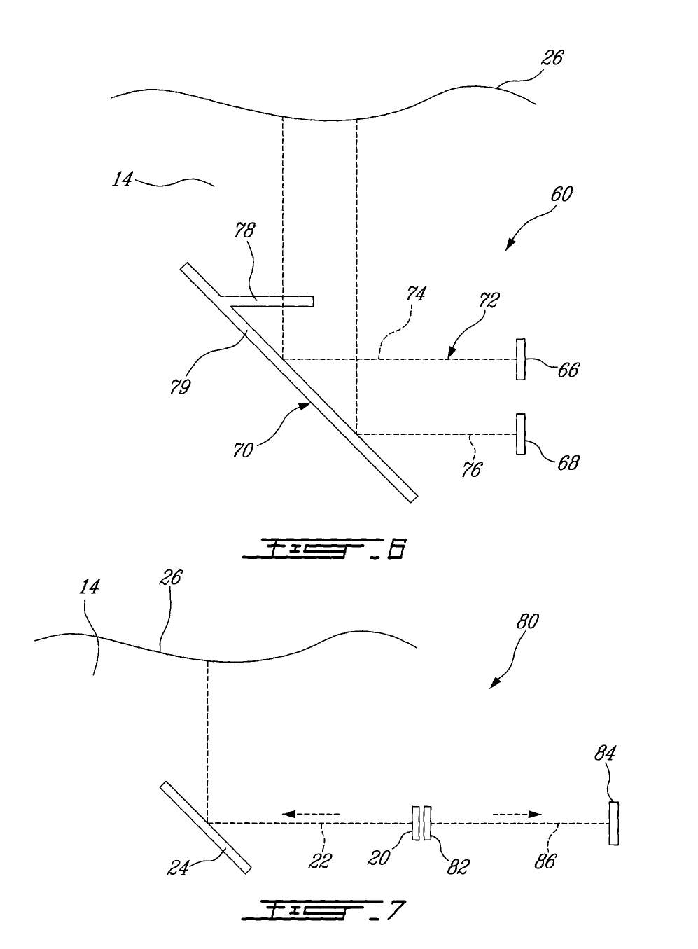

FIG. 7 illustrates a sensor assembly 80 for measuring the level of fluid in a tank (not shown) according to a seventh illustrative embodiment of the present invention.

Since the sensor assembly 80 is similar to the assembly 19, and for concision purposes, only the differences between the two assemblies 19 and 80 will be described herein in more detail.

The assembly 80 includes a second transducer 82 capable of emitting and receiving ultrasounds positioned adjacent the first transducer 20. Both transducers 20 and 82 are mounted in the tank (not shown) and secured to the bottom (not shown) thereof. The transducers 20 and 82 are both sealed. They can be assembled in a single casing or independently secured to the tank.

The operation of the transducer 20 in relation to the reflector 24 is as described with reference to FIG. 1.

The assembly 80 further includes a calibration target 84 similar to the target 40 (see FIG. 2), which is mounted to the tank so as to be positioned along the path 86 of the ultrasound beam of the second transducer 82. The target 84 shares similar purposes with the target 40 of the assembly 36, which will not be repeated herein for concision purposes. The pair constituted of the target 84 and the second transducer 82 does not have to be aligned with the path 22 as long as the target 84 and second transducer 82 are aligned so as to be operatively coupled. In some applications, one of the tank wall (not shown) may play the role of the target 84.

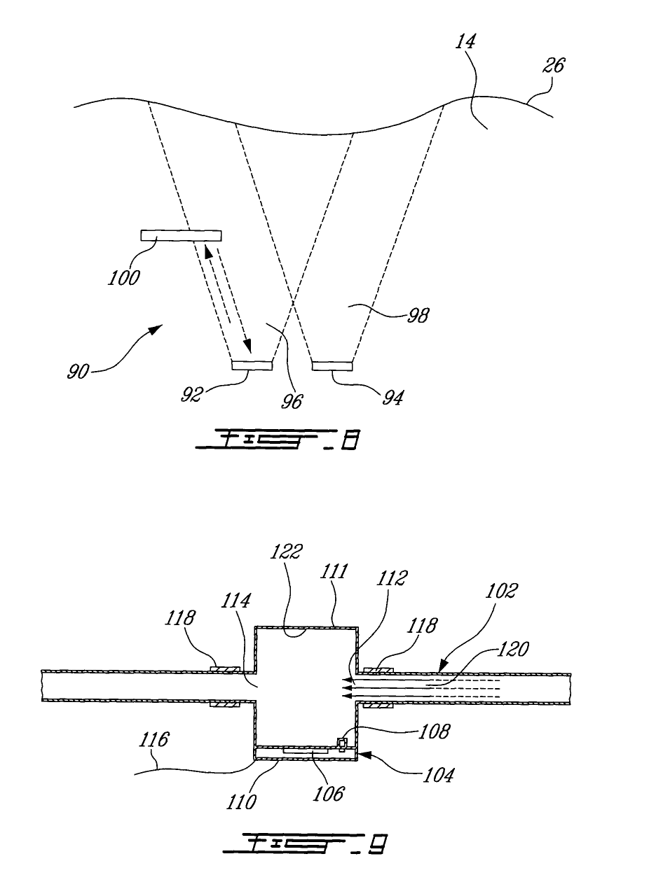

FIG. 8 illustrates a sensor assembly 90 for measuring the level 26 of fluid 14 in a tank (not shown) according to an eight illustrative embodiment of the present invention.

The assembly 90 comprises a first transducer 92, acting as an ultrasound emitter, and a second transducer 94, acting as an ultrasound receiver. The first and second transducers are mounted side by side adjacent one another and oriented towards the expected fluid interface 26 so that reflections caused by the ultrasound detecting beam 96 onto the interface 26 are within the field of view 98 of the second transducer 94.

The assembly 90 further includes a target 100 secured to the tank wall (not shown) or to the first or second transducer 92 or 94 for calibrating the system for the variation in the speed of sound in the fluid 14 as described hereinabove. The target 100 can be omitted when such calibration is not required by the application. The first and second transducers 92 and 94 are secured to the tank wall outside or inside thereof. They are either encased together or independently secured to the tank.

It is to be noted that the sensor assemblies 36, 46, 54, 60, 80 and 90 all operates under the method 200 described hereinabove.

FIG. 9 shows a pipe 102 incorporating a density meter 104 which includes a sensor assembly 106 according to a ninth illustrative embodiment of the present invention.

The sensor assembly 106 is identical to the assembly 90 with the following exceptions: the target 100 is omitted and a thermistor 108 is further provided. However, as will become more apparent upon reading the following description, the density meter can be used as a stand-alone application or part of a fluid level sensor assembly, such as the assemblies 19, 36, 46, 54, 60, 80 and 90.

The sensor assembly 106 and the thermistor 108 are both secured to the raised floor 110 of an enclosure 111, which further includes first and second opposite openings 112-114 respectively defining an inlet and an outlet for the fuel in the enclosure 111. The enclosure 111 and more specifically the wall of the floor 110, which protects the transducer 106 and in some applications the controller, is made of a hard material, such as such as stainless steel. In addition to protect the sensor 106 and the electronic not shown) from suffering corrosion by the fluid, the wall 122 of the enclosure 111 is used as a calibration target.

The thermistor 108 and the transducers of 92-94 of the sensor assembly 106 are coupled to a controller (not shown) via connectors 116 or using conventional wireless devices. Since such devices are believed to be well known in the art, and for concision purposes, they will not be described furtherin in more detail.

The enclosure 111 may be mounted to the pipe 102 via its inlet and outlet 112-114 through clamps 118 so that the enclosure defines an enlarged section of the pipe 102. Other alternative or further means can be used to mount the enclosure 111 to the pipe 102.

Other means than a raised floor can be used to protect the transducers 92-94, thermistor 108 and/or electronics from the liquid or fluid in the enclosure 111. These components can also be simply mounted to the enclosure 111 outside thereof or be mounted in a protective box (not shown) in the enclosure 111.

In operation, the enclosure 111 is filled by the fluid as it travels in the pipe 102 (see arrows 120). The thermistor 108 measures the temperature of the fluid in the enclosure 111 and the controller measures the time for an ultrasound pulse emitted by the emitter 92, which is reflected on the surface 122 of the enclosure facing the face of the transducer to return to the sensor assembly 106. The measured time of flight allows calculating the speed of sound providing the mixture temperature. This information and the identity of the fluids which compose the mixture is used by the controller (not shown) to calculate the ratio of the mixture ingredients.

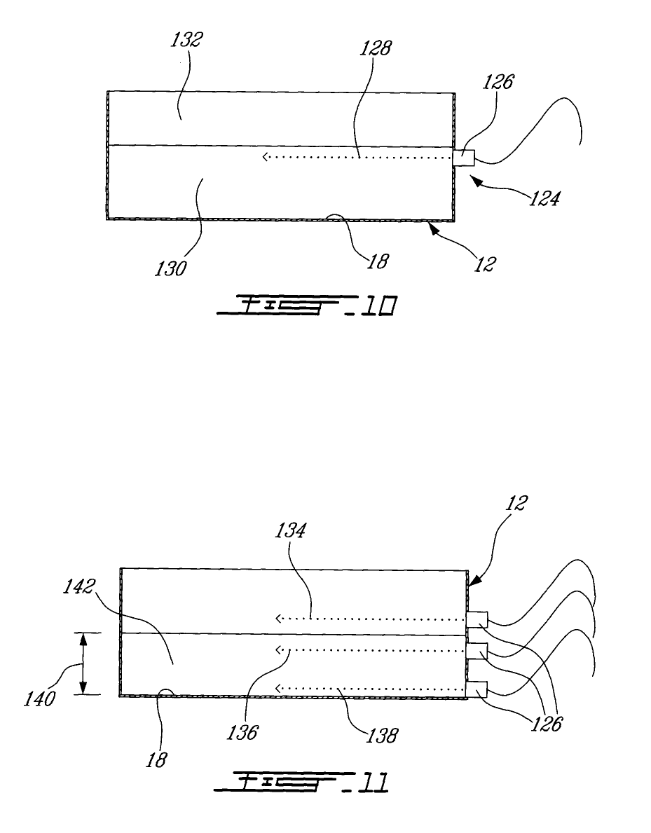

A sensor assembly 124 for measuring the fluid level in a tank according to a tenth illustrative embodiment of the present invention will now be described with reference to FIG. 10. Similarly to the sensor assemblies described hereinabove, the assembly 124 is configured to cancel the limitation of its transducer's dead zone. However, as will become more apparent upon reading the following description, the sensor assembly 124 operates in switch mode.

The sensor level switch assembly 124 includes an ultrasonic transducer 126 mounted to the side tank 12 outside thereof for emitting an ultrasound detecting beam 128 along a first horizontal path generally parallel to the bottom 18 of the tank 12 and for receiving ultrasound echoes incoming along the same path.

The transducer 126 is interfaced to the tank's external frame and is configured and calibrated before operation to detect through the liquid tank 12. The transducer 126 is so secured to the tank 12, relatively to the bottom 18, at the level that one wishes to detect.

In operation, the transducer 126 produces a different signal depending on whether the detecting beam 128 travels in a first fluid 130, which can be for example a liquid, in a second fluid 132, which can be for example air or another gas or in the interface between the two fluids 130-132. Providing the nature of the fluids in the tank 12, and the corresponding ultrasound signature, the transducer 126 can act as a digital level sensing switch for these fluids. It is to be noted that the above-described digital level sensing method does not result in any measurement limitation resulting from the dead zone.

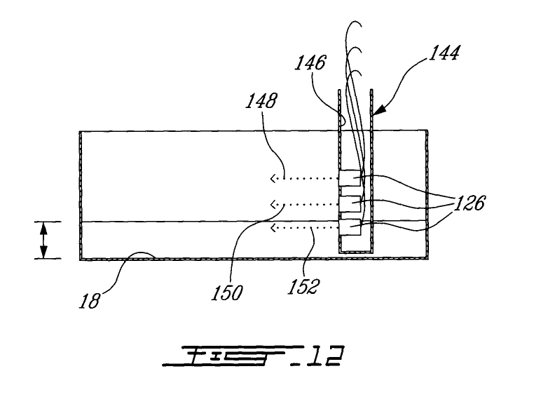

Also, as can be seen in FIG. 11, a plurality of transducers 126 (three shown) can be provided at different levels along the height of the tank to send a plurality of corresponding ultrasound detecting beams 134-138 generally parallel to the bottom 18 of the tank 12, yielding a plurality of digital level sensing switches that are independently triggered when the level 140 of fluid 142 reaches the corresponding height in the tank 12.

It is to be noted that the number of such digital level sensing switches may vary and so are their positions along the height in the tank 12. Also the controller (not shown) may be configured to recognize the signal signature of one or a plurality of fluids in the tank 12 so that each switch can be triggered when the level of a selected one or a plurality of fluids reach the level of the switch.

Each of the transducers 126 can be coupled to an individual controller (not shown) configured to receive and analyze the signal from the transducer 126 connected thereto to determine whether the nature of the fluid across the corresponding path 134, 136 or 138 has changed since the last measurement or all transducers 126 can be coupled to a single controller (not shown) configured to receive the signals from all three transducers 126 for similar treatment. Of course, in that later case, the controller allows associating a particular signal received to a corresponding transducer.

The transducers 126 can also be inserted in the tank 12. More specifically, as can be seen in FIG. 12, the transducers can be mounted in a fluid-proof tube guide 144. Similarly to their mounting to the tank 12, which as been described with reference to FIG. 10, the transducers 126 are then interfaced to the tube's internal face 146 for sending their ultrasound detecting beams along beam paths 148-152 generally parallel to the bottom 18 of the tank 12 and are configured and calibrated before operation to detect through the tube wall.

Systems for measuring fluid level in a tank provided with any one of the sensor assemblies illustrated in FIGS. 10, 11 or 12 can be further used to measure the fluid mixture in the tank 12 providing the following parameters to the controller: the speed of sound for different mixtures, the distance between the transducer(s) and the opposite tank wall, and the mixture temperature. As it has been described hereinabove, the mixture temperature can be obtained by providing for example a thermistor (not shown) in the tank 12, connected to the controller.

Also, any of the above-described systems including digital level sensing switch can further include a reference target (not shown) such as the target 40 in FIG. 2, to calibrate the system for the changes in the environment condition in the tank 12 as described hereinabove for example with reference to FIG. 2.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

1. A method for measuring at least one fluid level in a tank including at least one fluid comprising:
emitting an ultrasound detecting beam towards a surface of the at least one fluid in the tank from a first position relative to the tank, yielding at least a portion of a path of the ultrasound detecting beam being generally perpendicular to the bottom of the tank and defining an axis intersecting the bottom of the tank; the first position being adjacent the bottom of the tank;
receiving echoes from the ultrasound detecting beam reflected from the surface of the at least one fluid in the tank at a second position biased from the first position; and
determining the at least one fluid level using the echoes received from the ultrasound detecting beam and a distance between the first and second positions.

2. A method as recited in claim 1, wherein said emitting an ultrasound detecting beam towards a surface of the at least one fluid in the tank from a first position relative to the tank includes emitting the ultrasound detecting beam from the first position generally parallel to the bottom of the tank and reflecting the ultrasound detecting beam towards the surface of the at least one fluid in the tank from the second position.

3. A method as recited in claim 1, wherein a same transducer performs said emitting an ultrasound detecting beam and said receiving echoes.

4. A method as recited in claim 1, wherein a first transducer performs said emitting an ultrasound detecting beam and a second transducer performs said receiving echoes.

5. A method as recited in claim 1, wherein said determining the at least one fluid level further includes using a speed of sound in the at least one fluid to calculate a density of the at least one fluid.

6. A method as recited in claim 1, further comprising determining a speed of sound in the at least one fluid.

7. A method as recited in claim 6, wherein said determining a speed of sound in the at least one fluid includes i) further emitting the ultrasound detecting beam towards a target mounted in the tank, ii) receiving an echo from the target indicative therefrom, and iii) determining a delay between step i) and ii).

8. A method as recited in claim 7, wherein the target is a wall of the tank.

9. A method as recited in claim 1, further comprising i) further emitting the ultrasound detecting beam towards a target mounted in the tank, ii) receiving an echo from the target indicative therefrom, iii) determining a delay between step i) and ii) using a predetermined distance between the target and a transducer emitting the ultrasound detecting beam, and iv) determining one of the following parameters providing the others: an identity of the at least one fluid, a speed of sound in the at least one fluid, a temperature of the at least one fluid, and a ratio of one of the at least one fluid among the at least one fluid.

10. A method as recited in claim 1, wherein the at least one fluid includes a plurality of superimposed fluids.

11. A method as recited in claim 10, wherein the echoes are indicative of the ultrasound detecting beam being reflected from interfaces between the plurality of superimposed fluids; the at least one fluid level includes a plurality of fluid levels defined by the plurality of superimposed fluids; each of the plurality of fluid levels being determined using the echoes received from the ultrasound detecting beam and a distance between the first and second positions.

12. A method as recited in claim 1, wherein the at least one fluid includes a liquid and a gas.

13. A sensor assembly for measuring at least one fluid level in a tank comprising:
an ultrasonic transducer assembly mounted to the tank so as to emit an ultrasound detecting beam along a path generally parallel to the bottom of the tank and for receiving ultrasound echoes incoming along the path; the ultrasonic transducer assembly being characterized by a dead zone; and
a primary reflector mounted to the tank along the path of the ultrasound beam for reflecting the ultrasound detecting beam towards a surface of the at least one fluid in the tank and for reflecting back the ultrasound echoes received therefrom; the primary reflector being distanced from the ultrasonic transducer assembly from at least the length of the dead zone of the ultrasonic transducer.

14. A sensor assembly as recited in claim 13, further comprising a reference target for calibrating the sensor assembly for the speed of sound in the at least one fluid.

15. A sensor assembly as recited in claim 14, wherein the reference target is the primary reflector.

16. A sensor assembly as recited in claim 14, wherein the ultrasonic transducer assembly being further for emitting an ultrasound calibrating beam towards the reference target.

17. A sensor assembly as recited in claim 14, wherein the ultrasonic transducer assembly includes a single ultrasound transducer both for emitting the ultrasound detecting beam and for receiving the ultrasound echoes.

18. A sensor assembly as recited in claim 17, wherein the reference target is positioned between the ultrasound transducer and the primary reflector along the path generally parallel to the bottom of the tank.

19. A sensor assembly as recited in claim 17, wherein the reference target is mounted to the primary reflector.

20. A sensor assembly as recited in claim 17, further comprising a beam shape transformer for transforming the detecting beam.

21. A sensor assembly as recited in claim 20, wherein the beam shape transformer is part of the primary reflector.

22. A sensor assembly as recited in claim 17, wherein the ultrasound transducer is mounted to the tank so as to emit the ultrasound detecting beam adjacent the bottom of the tank.

23. A sensor assembly as recited in claim 22, further comprising a beam shape transformer for transforming the ultrasound detecting beam.

24. A sensor assembly as recited in claim 23, wherein the beam shape transformer is mounted to the ultrasonic transducer.

25. A sensor assembly as recited in claim 13, wherein the ultrasonic transducer assembly is mounted to a side wall of the tank outside thereof.

26. A sensor assembly as recited in claim 13, wherein the ultrasonic transducer assembly is sealingly mounted in the tank.

27. A sensor assembly as recited in claim 13, wherein the primary reflector and the ultrasonic transducer assembly are assembled together.

28. A sensor assembly as recited in claim 13, wherein the primary reflector includes a 45-degrees portion that reflects the ultrasound detecting beam at 90 degrees from the path generally parallel to the bottom towards the surface of the at least one fluid.

29. A sensor assembly as recited in claim 13, further comprising at least one secondary reflector for creating a secondary acoustic beam path between the primary reflector and the surface of the at least one fluid.

30. A sensor assembly as recited in claim 13, wherein the ultrasonic transducer assembly includes a first ultrasound transducer for emitting the ultrasound detecting beam along the path generally parallel to the bottom of the tank and a second transducer mounted adjacent the first ultrasound transducer for receiving ultrasound echoes incoming along the path parallel to the ultrasound detecting beam.

31. A sensor assembly for measuring fluid level in a tank comprising:
a first ultrasound transducer mounted to the tank for emitting an ultrasound detecting beam towards a surface of at least one fluid in the tank; and
a second ultrasound transducer mounted to the tank adjacent the first ultrasound transducer for receiving ultrasound echoes from the first detecting beam reflected from the surface of the at least one fluid in the tank.

32. A sensor assembly as recited in claim 31, further comprising a reference target for calibrating the sensor assembly for a speed of sound in the at least one fluid.

33. A sensor assembly as recited in claim 32, wherein the reference target partially intersects the ultrasound detecting beam.

34. A sensor assembly for measuring at least one fluid level in a tank comprising:
ultrasound emitting means for emitting an ultrasound detecting beam towards a surface of at least one fluid in the tank from a first position relative to the tank yielding at least a portion of a path of the ultrasound detecting beam being generally perpendicular to the bottom of the tank and which defines an axis intersecting the bottom of the tank; the first position being adjacent the bottom of the tank;
ultrasound receiving means for receiving echoes from the ultrasound detecting beam reflected from the surface of the at least one fluid in the tank at a second position biased from the first position; and
means for determining the at least one fluid level using the echoes received from the ultrasound detecting beam and a distance between the first and second positions.

35. A sensor assembly as recited in claim 34, wherein the at least one fluid includes at least one of a liquid and a gas.

36. An integrated method for measuring a fluid mixture level and density in a tank including a fluid mixture comprising:
emitting an ultrasound detecting beam i) towards a surface of the fluid mixture in the tank and ii) towards a reference target in the tank from a first position relative to the tank, yielding at least a portion of a path of the ultrasound detecting beam being generally perpendicular to the bottom of the tank and which defines an axis intersecting the bottom of the tank; the first position being adjacent the bottom of the tank;
receiving echoes from the ultrasound detecting beam reflected from a) the surface of the fluid in the tank and from b) the reference target at a second position biased from the first position;
determining the fluid mixture level using the echoes received from the ultrasound detecting beam and a distance between the first and second positions;
measuring a temperature of the fluid mixture in the tank; and
using the echoes from the ultrasound detecting beam reflected from the reference target and the temperature of the fluid mixture in the tank to determine the density of the fluid mixture.

37. A method for measuring the ratios of a fluid mixture, the method comprising:
providing an identity of the fluid mixture;
measuring a temperature of the fluid mixture;
emitting an ultrasound detecting beam towards a reference target in the fluid mixture; the reference target being positioned at a predetermined distance from a transducer emitting the ultrasound detecting beam;
receiving echoes from the ultrasound detecting beam reflected from the reference target after a measured time delay after the emitting an ultrasound detecting beam towards a reference target;
using the measured time delay, the temperature of the fluid mixture and the identity of the fluid mixture, determining the ratio of at least one fluid in the fluid mixture.
